(19) United States
(12) Patent Application Publication
(10) Pub. No.: US 2007/0068259 A1
(43) Pub. Date: Mar. 29, 2007

(54) Method and Apparatus For Selecting Wheel Rim Imbalance Correction Weight

(75) Inventor: Michael W. Douglas, St. Charles, MO (US)

Correspondence Address: POLSTER, LIEDER, WOODRUFF & LUCCHESI, 12412 POWERSCOURT DRIVE SUITE 200, ST. LOUIS, MO, 63131-3615, US

(73) Assignee: HUNTER ENGINEERING COMPANY, Bridgeton, MO (US)

(21) Appl. No.: 11/530,401

(22) Filed: Sep. 8, 2006

Related U.S. Application Data
(60) Provisional application No. 60/721,205, filed on Sep. 28, 2005.

(51) Int. Cl. G01H 1/00

(52) U.S. Cl. 73/662; 73/660

(57) ABSTRACT

A method for selecting a style of clip-on imbalance correction weight for application to a vehicle wheel rim edge during a vehicle wheel imbalance correction procedure. A wheel rim edge or lip is scanned to establish a representation of the wheel rim edge profile or lip configuration. The established representation of the wheel rim edge profile or lip configuration is compared with a plurality of clip-on imbalance correction weight profiles and clip shapes to identify at least the best-fit match between the wheel rim edge profile or lip configuration and a clip-on imbalance correction weight in the set of available weight profiles.

### CROSS-REFERENCE TO RELATED APPLICATIONS

The present application is related to, and claims priority from, U.S. Provisional Patent Application Ser. No. 60/721,205 filed on Sept. 28, 2005, which is herein incorporated by reference.

### STATEMENT REGARDING FEDERALLY SPONSORED RESEARCH

Not Applicable.

### BACKGROUND OF THE INVENTION

The present invention related generally to vehicle wheel balancing equipment, and specifically to vehicle wheel balancing equipment utilizing techniques to accurately measure features of a vehicle wheel rim during a vehicle wheel balancing procedures to facilitate the proper selection and placement of an imbalance correction weight type for application to the vehicle wheel rim.

It is well known in the art of vehicle wheel balancing that a determination of an imbalance present in a vehicle wheel assembly may be carried out by an analysis with reference to the phase and amplitude of the mechanical vibrations caused by the rotating unbalanced mass in the vehicle wheel assembly, such as shown in U.S. Pat. No. 6,484,574 to Douglas. The mechanical vibrations are measured as motions, forces, or pressures by means of transducers, which convert the mechanical vibrations into electrical signals for analysis by a processing system. Each signal is the combination of fundamental oscillations caused by the imbalance and noises.

Once the magnitude and phase of the imbalance in a vehicle wheel assembly has been identified, it is typically corrected by the application of one or more imbalance correction weights to the vehicle wheel assembly. To compensate for a combination of static imbalance (where the heaviest part of the assembly will seek a position directly below the mounting shaft) and couple imbalance (where the assembly upon rotation causes torsional vibrations on the mounting shaft), at least two correction weights are required which are separated axially along the wheel surface, coincident with weight location or imbalance correction “planes”.

A variety of types of imbalance correction weights are available for placing on the vehicle wheel assembly to correct the measured imbalance. For example, adhesive-backed weights may be applied to a surface of the wheel rim, patch balance weights may be applied to inner surface of a tire, and hammer-on or clip-on weights are available from a number of different manufacturers for attachment to the wheel rim lip. When using clip-on weights, the “left plane” comprises the left (innermost) rim lip circumference while the “right plane” comprises the right rim lip. If adhesive weights are used, the planes can reside anywhere between the wheel rim lips, barring physical obstruction such as wheel spokes, welds, and regions of excessive surface curvature.

To facilitate the placement of imbalance correction weights on a vehicle wheel assembly, a variety of systems currently in use are configured to acquire measurements or data from which a representation of a vehicle wheel rim surface profile can be determined. These systems may include mechanical devices for scanning a wheel rim profile, such as shown in U.S. Pat. No. 5,915,274 to Douglas, acoustic measurement devices such as shown in U.S. Pat. No 5,189,912 to Quinlan et al., or imaging devices such as shown in U.S. Pat. No 6,484,574 to Douglas which may be configured to acquire images of a wheel rim which is illuminated by ambient light or by projected illuminations such as a scanning laser beam.

While information associated with a vehicle wheel rim surface profile is commonly utilized to assist in the selection of a placement location for one or more imbalance correction weights, it may be further utilized to identify the specific type of vehicle wheel rim from a database of predetermined wheel rim types, such as shown in U.S. Pat. No. 6,983,656 B2 to Cullum et al. The Cullum et al. reference discloses a vehicle wheel balancer system and method which is configured to acquire dimensional measurements of a wheel rim edge, and to compare the acquired measurements to a set of predetermined wheel rim edge measurements previously stored in a database to identify a specific type of wheel rim edge, together with a corresponding type of clip-on imbalance correction weight style for application to the identified wheel rim edge.

While comparison of measured wheel rim edge dimensions with a database of predetermined wheel rim edge measurements to identify a specific type of wheel rim edge, together with a corresponding type of clip-on imbalance correction weight style, may be useful when the wheel rim is in new or undamaged condition, vehicle wheel rim edges are often damaged from contact with road surfaces, curbs, potholes, etc. or have been resurfaced during a refinishing, chroming, or painting procedure, and hence may no longer have dimensions which precisely match the predetermined wheel rim edge measurements stored in the database and which are associated with a specific type of wheel rim edge. Similarly, new wheel rim styles or custom wheel rims may similarly have wheel rim edge measurements which do not match any predetermined wheel rim edge measurements associated with a specific type of wheel rim edge stored in a database.

Accordingly, it would be advantageous to provide a vehicle wheel balancing system, which is capable of observing a profile or contour of a wheel rim edge and lip characteristics, with a method for identifying a clip-on imbalance correction weight style which is best suited for application to the observed wheel rim edge or lip characteristics, without the need to match the observed wheel rim edge to a specific predetermined wheel rim edge style.

It would further be advantageous to provide a vehicle wheel balancing system with the ability to identify a specific style or shape of an imbalance correction weight being utilized to correct an imbalance on a vehicle wheel, and to adjust identified imbalance correction weight amounts and placement locations to compensate for the specific axial and radial offset of the center of gravity associated with the identify style or shape of imbalance correction weight.

It would further be advantageous to provide a vehicle wheel balancing system with the ability to determine if an operator has applied the correct style or shape of imbalance correction weight to a vehicle wheel, and to provide a warning or other indication to the operator if an incorrect style or shape of imbalance correction weight has been applied.

### BRIEF SUMMARY OF THE INVENTION

The present invention provides a method for selecting a type of clip-on imbalance correction weight for application to a vehicle wheel rim edge during a vehicle wheel imbalance correction procedure. The method includes an initial step of scanning a wheel rim edge to establish a representation of the wheel rim edge profile or contour. The established representation of the wheel rim edge profile or contour is compared with a plurality of clip-on imbalance correction weight profiles to identify a best-fit match between the wheel rim edge profile and a clip-on imbalance correction weight profile.

In an alternate embodiment, the present invention provides an apparatus for selecting a best-fit match between profiles of clip-on imbalance correction weights and an observed vehicle wheel rim edge for application to the vehicle wheel rim edge to correct a measured imbalance. The apparatus includes at least one sensor for scanning the wheel rim edge to acquire data from which a representation of the wheel rim edge profile or contour may be established by an associated processing system. The processing system is further configured to compare the established representation of the wheel rim edge profile or contour with a plurality of clip-on imbalance correction weight profiles to identify a best-fit match between the wheel rim edge profile and a clip-on imbalance correction weight profile.

The foregoing and other objects, features, and advantages of the apparatus and methods of the present invention as well as presently preferred embodiments thereof will become more apparent from the reading of the following description in connection with the accompanying drawings.

### BRIEF DESCRIPTION OF THE SEVERAL VIEWS OF THE DRAWINGS

In the accompanying drawings which form part of the specification:

FIG. 1 is a flow chart illustrating an embodiment of the method of the present invention for selecting a clip-on imbalance correction weight type for application to a vehicle wheel rim edge;

FIGS. 2A-2G are sectional illustrations of prior art wheel rim edge types and associated clip-on imbalance weights;

FIG. 3 is a perspective illustration of a prior art vehicle wheel balancer system;

FIG. 4 is a block diagram of the functional components of a prior art vehicle wheel balancer system;

FIG. 5A is a perspective view of a strip of prior art ¼ oz. square adhesive imbalance correction weights;

FIG. 5B is a cross-sectional view of the adhesive imbalance correction weights of FIG. 5A, illustrating the center-of-gravity;

FIG. 6A is a perspective view of a strip of prior art ¼ oz. rectangular adhesive imbalance correction weights;

FIG. 6B is a cross-sectional view of the adhesive imbalance correction weights of FIG. 6A, illustrating the center-of-gravity;

FIG. 7A is a perspective view of a strip of prior art ½ oz. rectangular adhesive imbalance correction weights;

FIG. 7B is a cross-sectional view of the adhesive imbalance correction weights of FIG. 7A, illustrating the center-of-gravity;

FIG. 8A is a perspective view of a strip of prior art ½ oz. flat adhesive imbalance correction weights;

FIG. 8B is a cross-sectional view of the adhesive imbalance correction weights of FIG. 8A, illustrating the center-of-gravity;

FIG. 9A is a perspective view of a strip of prior art 50 g adhesive imbalance correction weights;

FIG. 9B is a cross-sectional view of the adhesive imbalance correction weights of FIG. 9A, illustrating the center-of-gravity;

FIG. 10A is a front view of a prior art 4.0 oz. clip-on imbalance correction weight of a first style;

FIG. 10B is a sectional view of the clip-on imbalance correction weight of FIG. 10A, illustrating the center-of-gravity;

FIG. 11A is a front view of a prior art 4.0 oz. clip-on imbalance correction weight of a second style;

FIG. 11B is a sectional view of the clip-on imbalance correction weight of FIG. 11A, illustrating the center-of-gravity;

FIG. 12A is a front view of a prior art 4.0 oz. clip-on imbalance correction weight of a third style;

FIG. 12B is a sectional view of the clip-on imbalance correction weight of FIG. 12A, illustrating the center-of-gravity;

FIG. 13 is a sectional view of a prior art lead 50 g clip-on imbalance correction weight; and

FIG. 14 is a sectional view of a prior art zinc 50 g clip-on imbalance correction weight.

Corresponding reference numerals indicate corresponding parts throughout the several figures of the drawings.

### DESCRIPTION OF THE PREFERRED EMBODIMENT

The following detailed description illustrates the invention by way of example and not by way of limitation. The description clearly enables one skilled in the art to make and use the invention, describes several embodiments, adaptations, variations, alternatives, and uses of the invention, including what is presently believed to be the best mode of carrying out the invention.

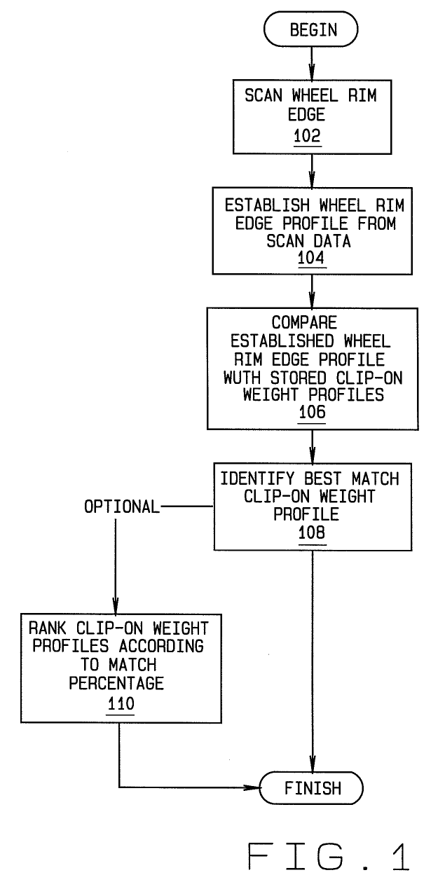

Turning to the figures, and to FIG. 1 in particular, a method 100 of the present invention is illustrated generally for use with any of a variety of vehicle wheel balancer systems 200 which are configured to acquire wheel rim edge and lip profile data distinguishing rim edge and lip features to at least 0.1 inches and 0.1 degrees of resolution. Initially, the method 100 requires the vehicle wheel balancer system 200 to scan the wheel rim edge (Box 102) to acquire data from which a wheel rim edge or lip profiles can be established (Box 104). This may be done with a tire mounted to the wheel rim, in which case, only the wheel rim edge profile can be established. If wheel rim is scanned without a tire mounted thereon, the full profile of the wheel lip, including contour and thickness may be obtained by scanning both the “outside” surface and the “inside” surface which is normally concealed from view by the bead and sidewall portions of a tire mounted to the vehicle wheel rim. The wheel rim edge or lip profile may correspond either to the actual wheel rim edge or lip profile at the specific location at which the wheel rim was scanned, or may be an “average” wheel rim edge or lip profile generated from data acquired at multiple locations about the circumference of the wheel rim.

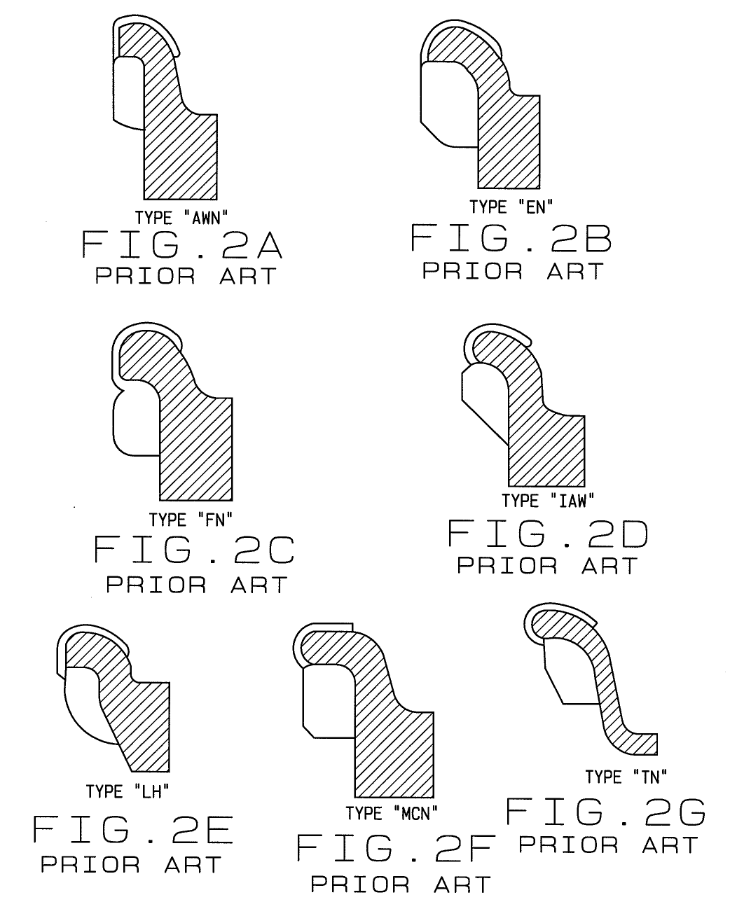

The method of the present invention is independent of the specific manner in which the data is acquired, i.e. optically, mechanically, or ultrasonically, provided that the data has sufficient resolution to enable a meaningful comparison between the generated wheel rim edge or lip profile and a set of stored clip-on weight-type profiles (Box 106). The comparison between the generated profile of the wheel rim edge or lip and the stored clip-on weight profiles identifies a clip-on imbalance correction weight type, such as those shown in FIGS. 2A-2G, from the selection of available clip-on imbalance correction weights, which has a profile best matching the generated profile of the wheel rim edge (Box 108). Additional clip-on weights may optionally be identified and/or ranked according to a match percentage with the generated profile of the wheel rim edge (Box 110). Once at least one suitable clip-on weight is identified, additional information about that specific style of clip-on weight, such as center-of-gravity characteristics, may be retrieved from a database and either displayed to an operator or utilized in subsequent imbalance correction calculations.

The comparison between the generated profile of the wheel rim edge or lip and the stored clip-on weight profiles (Box 106) is preferably implemented using a mathematical process which compares the generated profile of the wheel rim edge or lip with each stored clip-on weight profile to identify the profile of the clip-on weight having the least amount of deviation from the generated profile of the wheel rim edge, or the clip-on weight profile having the least amount of deviation from the generated profile and thickness of the wheel rim lip. Those of ordinary skill in the art will recognize that a variety of mathematical techniques may be utilized in the comparison process, including iterative approaches, minimization algorithms, and curve-fitting algorithms.

Each evaluated surface or profile of a clip-on weight may be ordered in a logical fashion, or assigned a value, representative of the “fit” or match percentage of that particular clip-on weight compared with the generated profile of the wheel rim edge or lip, enabling a meaningful selection of a type of clip-on imbalance correction weight for application to the vehicle wheel rim edge or lip during an imbalance correction procedure.

It will be advantageously seen that the method 100 of the present invention enables a vehicle wheel balancer system 200 to identify a best match type of clip-on imbalance correction weight (Box 108) for application to a scanned vehicle wheel rim, independent of an identification of the specific type or designation of the wheel rim edge, thereby enabling the vehicle wheel balancer system 200 to identify clip-on imbalance correction weights which are suited for wheel rim edges which do not conform to a known or predetermined “type”, i.e., such as custom vehicle wheel rim edges, damaged vehicle wheel rim edges, or resurfaced vehicle wheel rim edges.

It will be further advantageously seen that the method 100 of the present invention, when optionally utilized to rank or identify different types of clip-on imbalance correction weights according to a “fit” or match percentage with a vehicle wheel rim edge or lip profile (Box 110), can provide an operator with a selection of several clip-on imbalance correction weight types for use with a scanned vehicle wheel rim edge or lip profile. This optional feature is particularly advantageous to facilitate selection of a suitable clip-on imbalance correction weight type for application to a vehicle wheel rim edge in the event the identified “best match” clip-on weight type is unavailable, such as by providing a ranked list of alternative selections.

Turning to FIG. 3, an exemplary vehicle wheel balancer system 200 which may be configured to employ the methods of the present invention is shown. The vehicle wheel balancer system 200 may include a housing 202 supporting a spindle shaft 204 onto which a vehicle wheel assembly 10 is mounted for balancing inspection, compartments 206 for storing imbalance correction weights, and a console 208 having input and output components such as buttons 210 and knobs 212 for directing the operation of the vehicle wheel balancer system 200. A display device 214, such as a CRT or LCD display may optionally be provided, as well as a protective hood or shield 216 configured for lowering over a vehicle wheel assembly 10 during a balance measurement procedure. Some vehicle wheel balancer systems 200 may further include a load roller 218 configured to exert forces against a vehicle wheel assembly 10 mounted to the spindle shaft 204, and one or more measurement devices such as measurement arms 220, imaging sensors (not shown), or ultrasonic sensors (not shown) disposed to acquire measurements of associated with a vehicle wheel assembly 10 mounted to the spindle shaft 204.

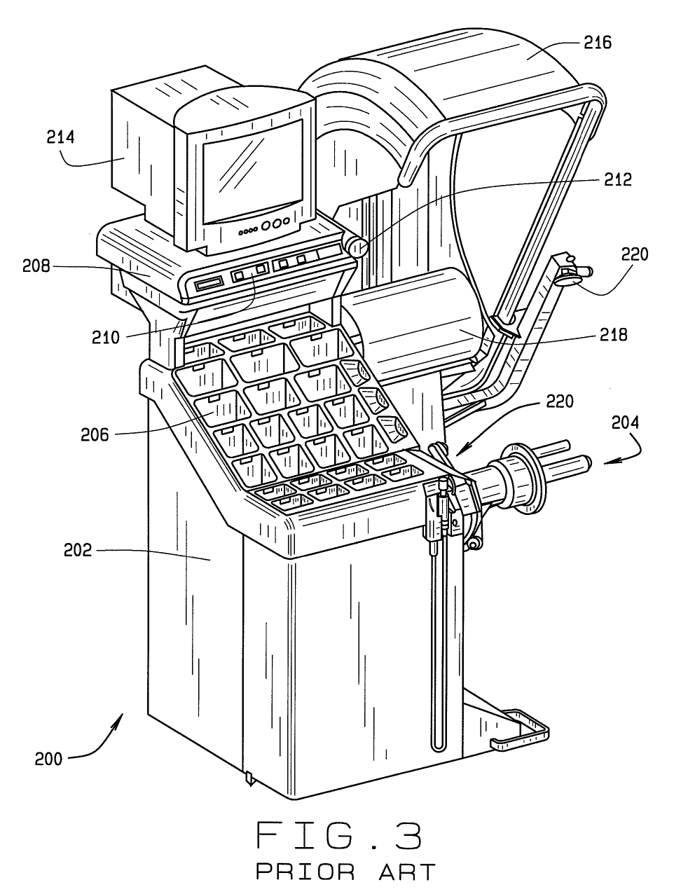

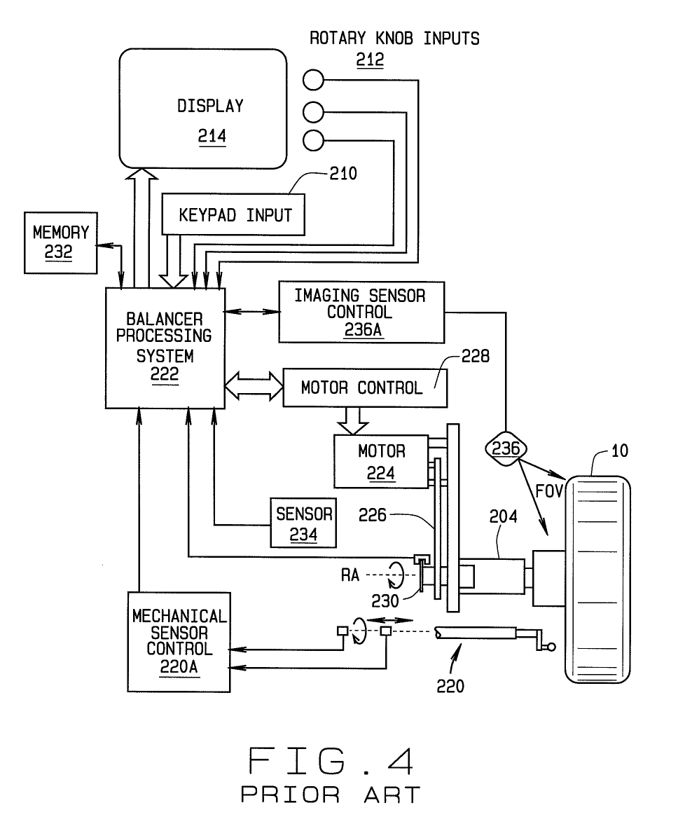

As shown in FIG. 4, the various components of the vehicle wheel balancer system 200 are interconnected through a balancer processing system 222. The spindle shaft 204 is driven by a bidirectional, multi-rpm, variable torque motor drive 224 through a belt 226 or other suitable coupling. Operation of the motor drive 224 is preferably controlled by a motor control unit 228, in response to signals received from the balancer processing system 222. Mounted on one end of the spindle 204 is a conventional quadrature phase optical shaft encoder 230 which provides rotational position information to the balancer processing system 222. The balancer processing system 222 is capable of executing balancer software applications and driving the optional display 246 or other interfaces configured to provide information to an operator. The balancer processing system 222 is connected to at least one electronic memory 232 in which programs and data such as calibration data, imbalance correction weight data, and vehicle-specific specifications are stored, and which may be used for temporary data storage.

During operation of the vehicle wheel balancing system 200, a wheel assembly 10 under test is removably mounted on the spindle shaft 204 for rotation. To determine wheel assembly imbalances, the vehicle wheel balancer system 200 includes suitable sensors 234, such as a pair of force transducers, which are coupled to the balancer structure 202. These sensors 234 and their corresponding interface circuitry to the balancer processing system 222 are well known in the art, such as seen in U.S. Pat. No. 5,396,436 to Parker et al., herein incorporated by reference.

To acquire data representative of the rim edge or lip profile of the vehicle wheel assembly 10, the vehicle wheel balancing system 200 may employ any of a variety of known sensors, including one or more mechanical sensor arm assemblies 220, one or more imaging sensors 236 disposed with a field of view (FOV) orientated towards a desired portion of the wheel assembly 10 mounted on the spindle 204, or one or more ultrasonic sensors (not shown). To acquire complete information on the wheel rim lip, such as profile and thickness on the “inside” surface of the wheel rim lip, it is necessary for the tire to be dismounted from the wheel rim. Each sensor may be coupled to the balancer processing system 222 through a corresponding sensor control module, such as a mechanical sensor control 220A or an imaging sensor control 236A, or may be directly linked to the balancer processing system 222. Any type or configuration of the sensors may be utilized by the vehicle wheel balancing system 200 for purposes of carrying out the method 100 of the present invention provided that the sensors can acquire sufficient data to generate a profile of the rim edge or lip of the vehicle wheel assembly 10 having sufficient resolution required to differentiate between different clip-on imbalance correction weight types suitable for application thereto.

Preferably, the wheel balancing system 200 processing system 222 is configured with suitable software program instructions to implement the methods of the present invention, utilizing data received from the sensors to generate a representation of a wheel rim edge or lip profile, and data stored in the memory 232 which is representative of the profiles and characteristics of different clip-on imbalance correction weight types. The software program instructions configure the processing system to carry out the steps of the methods, and to provide a suitable indication to an operator, such as through control of the display 214, of the best-fit clip-on imbalance correction weight type for a vehicle wheel assembly mounted to the spindle shaft 204. The processing system may be further configured to utilize stored characteristics of a selected imbalance correction weight type, such as center-of-gravity factors, during the determination of imbalance correction weight amounts and placements locations on the vehicle wheel assembly to correct measured imbalances.

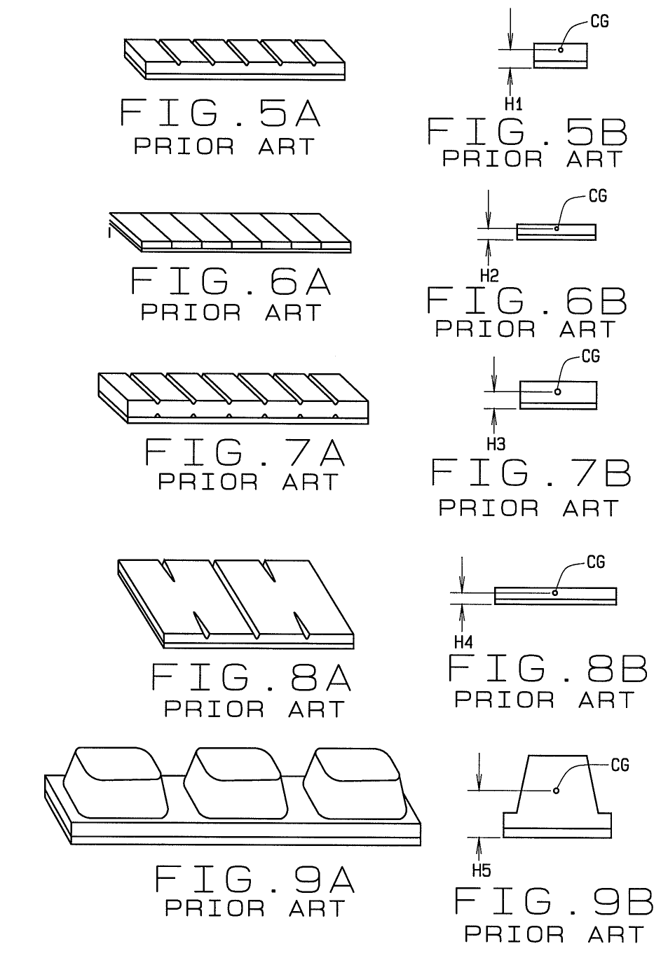

Turning to FIGS. 5-12, it becomes readily apparent how the characteristics of imbalance correction weights of different styles can alter the effect of the imbalance correction weight on a vehicle wheel assembly imbalance. For adhesive imbalance correction weight styles, such as those shown in FIGS. 5-9, the thickness of the weight determines the location of the weight's center-of-gravity in a radial direction when placed on a vehicle wheel assembly surface. Different styles of adhesive imbalance correction weights from different manufacturers may each have a different center-of-gravity (CG), even for weights of the same amount, as illustrated by FIGS. 5B and 6B, and by FIGS. 7B and 8B. Relatively large adhesive imbalance correction weights, such as illustrated in FIGS. 9A and 9B have significant thickness, resulting in a weight CG which may be as much as ¼ inch or more radially displaced from the wheel rim surface.

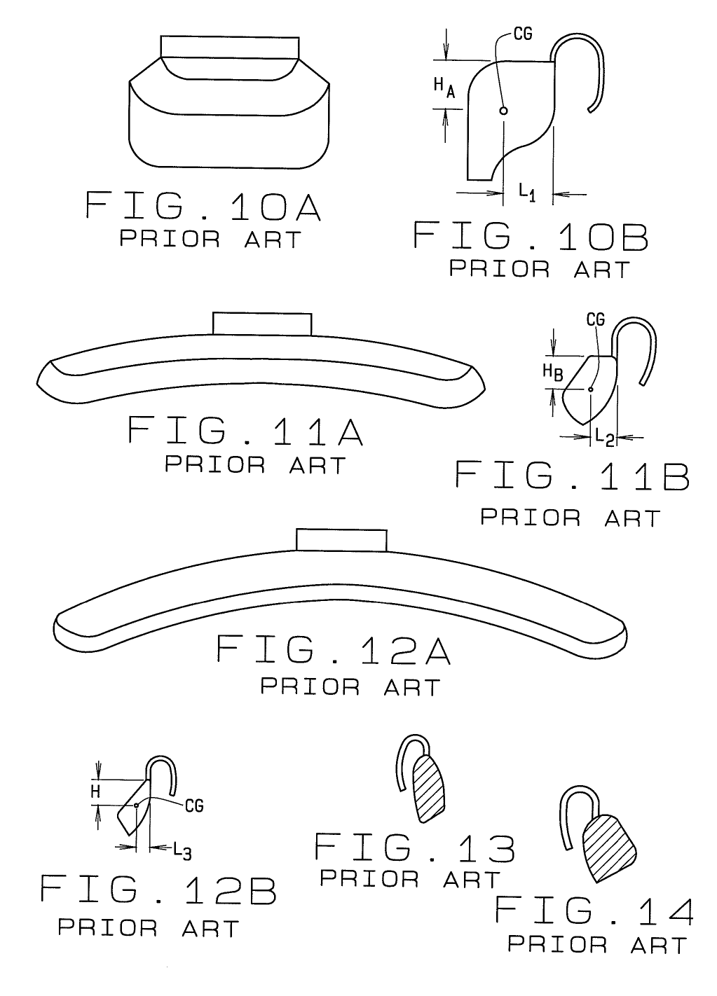

Similar effects are found between different styles of clip-on imbalance correction weights of the same weight amounts. For example, as is illustrated in FIGS. 10-12, different styles of 4.0 oz. clip-on weights may have significantly different shapes. With clip-on weights, the shape of the weight need only conform to the wheel rim surface along one edge. As such, a manufacturer may choose to add mass to the weight in a axial direction (parallel to the wheel assembly axis of rotation), resulting in a short, thick weight which protrudes outward from the wheel rim, such as seen in FIG. 10A, or may add mass to the weight in the lateral direction, resulting in a long thin weight which fits snug against the wheel rim edge, as seen in FIG. 12A. While each of these styles of clip-on imbalance correction weights has the same weight amount of 4.0 oz, as can be seen in the sectional views of FIGS. 10B-12B, the radial and axial location of the weight CG is different.

The type of material an imbalance correction weight is formed from may further affect the weight CG or other characteristics of an imbalance correction weight. For example, as shown in FIGS. 13 and 14, clip-on imbalance correction weights of the same weight amount, i.e. 50 g., will have different cross-sectional areas, and correspondingly, different weight CGs when formed from two different metals, such as lead, steel, or zinc, due to the differing density of material.

As vehicle wheel balancer systems become increasingly accurate, it is possible for a vehicle wheel balancer system 200 to measure the balance effects resulting from imbalance correction weight CG variations. These weight CG variations may be due to the shape, size, or density of the imbalance correction weight, as well as the degree of curvature of the weight, such as described in U.S. Pat. No 5,365,786 to Douglas. To accurately correct a measured imbalance in a vehicle wheel assembly, the vehicle wheel balancer system 200 must accurately calculate the effect of an imbalance correction weight placed on the vehicle wheel assembly at an indicated location will have. A theoretical imbalance correction weight having zero thickness which is placed on the wheel assembly at a radial distance corresponding to the wheel rim diameter, will have a different effect on the vehicle wheel assembly imbalance from an actual imbalance correction weight having a weight CG which is displaced radially inward from the wheel rim diameter. Accordingly, a vehicle wheel balancer system 200 of the present invention may optionally be configured to utilize the weight CG information associated with a selected imbalance correction weight, together with data associated with the vehicle wheel assembly to identify a imbalance correction weight amount and placement location to correct a measured imbalance.

Accordingly, a vehicle wheel balancer system 200 of the present invention may optionally include a database of imbalance correction weight characteristics for different styles or types of imbalance correction weights. These stored characteristics may include profile data, as set forth above, center of gravity data, or material type data. When an type of imbalance correction weight is selected for use to correct a measured imbalance in a vehicle wheel assembly, the vehicle wheel balancer system 200 may be configured to access the database of imbalance correction weight characteristics, and to utilize the data stored therein which is associated with the selected weight type to determine the amount of imbalance correction weight to be added to the vehicle wheel assembly, as well as the placement location thereon.

In an alternate embodiment, a vehicle wheel balancer system 200 of the present invention may be configured to verify that an operator has installed a proper type of imbalance correction weight onto a vehicle wheel assembly. This verification may be carried out by a variety of methods and techniques. In one embodiment, a vehicle wheel balancer system 200 configured with at least one imaging sensor may be configured to acquire an image of the imbalance correction weight after placement onto a surface of the vehicle wheel assembly, and to compare the acquired image against a reference image of the imbalance correction weight style stored in a memory, If the acquired image and the reference image do not match to within a predetermined tolerance, a warning or other suitable indication is provided.

Alternatively, the application of an improper imbalance correction weight can be identified by measuring the effect of the imbalance correction weight on the measured imbalance of the vehicle wheel. If it is assumed that the operator has applied the correct weight amount, at the correct weight location, a variation in the resulting imbalance forces present in the vehicle wheel assembly from those expected following application of the correct type of imbalance correction weight may be due to the incorrect weight having a different weight CG from the correct weight type. Accordingly, a warning or other suitable indication is provided to the operator.

The present invention can be embodied in-part in the form of computer-implemented processes and apparatuses for practicing those processes. The present invention can also be embodied in-part in the form of computer program code containing instructions embodied in tangible media, such as floppy diskettes, CD-ROMs, hard drives, or an other computer readable storage medium, wherein, when the computer program code is loaded into, and executed by, an electronic device such as a computer, micro-processor or logic circuit, the device becomes an apparatus for practicing the invention.

The present invention can also be embodied in-part in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented in a general-purpose microprocessor, the computer program code segments configure the microprocessor to create specific logic circuits.

In view of the above, it will be seen that the several objects of the invention are achieved and other advantageous results are obtained. As various changes could be made in the above constructions without departing from the scope of the invention, it is intended that all matter contained in the above description or shown in the accompanying drawings shall be interpreted as illustrative and not in a limiting sense.

1. A method for identifying a style of clip-on imbalance correction weight for application to a vehicle wheel rim edge, comprising the steps of:
scanning the vehicle wheel rim edge;
determining a profile of the scanned wheel rim edge;
comparing said profile with a plurality of stored clip-on imbalance correction weight profiles; and
responsive to said comparison, identifying at least one style of clip-on imbalance correction weight for application to the vehicle wheel rim edge.

2. The method of claim 1 wherein said step of identifying at least one style of clip-on imbalance correction weight for application to the vehicle wheel rim edge identifies at least a style of clip-on imbalance correction weight having a best-fit to said determined profile of the vehicle wheel rim edge.

3. The method of claim 1 wherein said step of identifying at least one style of clip-on imbalance correction weight for application to the vehicle wheel rim edge identifies a plurality of styles of clip-on imbalance correction weights for application to the vehicle wheel rim edge.

4. The method of claim 3 further including the step of ranking said plurality of identified styles of clip-on imbalance correction weights based on said comparison to said determined profile of the vehicle wheel rim edge.

5. The method of claim 1 wherein said comparing step includes a best-fit analysis between each of said plurality of stored clip-on imbalance correction weight profiles and said determined profile of the vehicle wheel rim edge.

6. The method of claim 1 wherein said comparing step includes a deviation minimization analysis between each of said plurality of stored clip-on imbalance correction weight profiles and said determined profile of the vehicle wheel rim edge.

7. The method of claim 1 wherein plurality of stored clip-on imbalance correction weight profiles include at least one of an AWN, EN, FN, IAW, LH, MCN, and TN clip-on imbalance correction weight styles.

8. The method of claim 1 wherein said step of scanning the vehicle wheel rim edge utilizes at least one of a mechanical, optical, or ultrasonic sensor.

9. The method of claim 1 further including the step of displaying a representation of said at least one style of identified clip-on imbalance correction weight to an operator.

10. The method of claim 1 wherein said wheel rim edge defines a lip dividing the wheel rim between an inside surface and an outside surface; and wherein said step of determining a profile of the scanned wheel rim edge includes determining a profile of an inside surface of the lip.

11. An improved wheel balancer having a balancer processing system, spindle shaft for mounting a vehicle wheel assembly consisting of at least a vehicle wheel rim for rotation thereon, and a wheel rim measurement system for acquiring data representative of a profile of the wheel rim edge, the improvement comprising:
wherein the balancer processing system is configured with program instructions to compare data from the wheel rim measurement system which is representative of a wheel rim edge profile with a plurality of stored clip-on imbalance correction weight profiles; and
wherein the balancer processing system is further configured with program instructions responsive to said comparison to identify a style of clip-on imbalance correction weight for application to the vehicle wheel rim.

12. The improved vehicle wheel balancer of claim 11 wherein the balancer processing system is further configured with program instructions responsive to said comparison to identify at least a best-fit style of clip-on imbalance correction weight for application to the vehicle wheel rim.

13. The improved vehicle wheel balancer of claim 11 wherein the balancer processing system is further configured with program instructions responsive to said comparison to identify a plurality of styles of clip-on imbalance correction weights for application to the vehicle wheel rim, said plurality of types having a ranked order.

14. The improved vehicle wheel balancer of claim 13 wherein said ranked order is based on a comparison between profiles of each of said styles of clip-on imbalance correction weights and said representative of said wheel rim edge profile.

15. The improved vehicle wheel balancer of claim 12 wherein the wheel rim measurement system for acquiring data representative of a profile of the wheel rim edge includes at least one of a mechanical, optical, or ultrasonic sensor.

16. A method for selecting a type of clip-on imbalance correction weight in a vehicle wheel balancing system including an imaging sensor assembly configured to provide dimensional data associated with a wheel rim edge in a field of view encompassing at least a portion of a vehicle wheel assembly undergoing a vehicle wheel balancing procedure, comprising:
observing the vehicle wheel rim edge with the imaging sensor assembly to generate an image of the vehicle wheel rim edge;
generating a representation of the profile of the scanned wheel rim edge from said generated image;
comparing said profile representation with a plurality of stored clip-on imbalance correction weight profiles; and
responsive to said comparison, identifying at least one style of clip-on imbalance correction weight for application to the vehicle wheel rim edge.

17. The method of claim 16 wherein said step of identifying at least one style of clip-on imbalance correction weight for application to the vehicle wheel rim edge identifies at least a style of clip-on imbalance correction weight having a best-fit to said generated profile representation of the vehicle wheel rim edge.

18. The method of claim 16 wherein said step of identifying at least one style of clip-on imbalance correction weight for application to the vehicle wheel rim edge identifies a plurality of styles of clip-on imbalance correction weights for application to the vehicle wheel rim edge.

19. The method of claim 18 further including the step of ranking said plurality of identified styles of clip-on imbalance correction weights based on said comparison of said plurality of stored clip-on imbalance correction weight profiles to said generated profile representation of the vehicle wheel rim edge.

20. The method of claim 16 wherein said comparing step includes a best-fit analysis between each of said plurality of stored clip-on imbalance correction weight profiles and said generated profile representation of the vehicle wheel rim edge.

21. The method of claim 16 wherein said comparing step includes a deviation minimization analysis between each of said plurality of stored clip-on imbalance correction weight profiles and said generated profile representation of the vehicle wheel rim edge.

22. The method of claim 16 further including the step of providing a display of said generated profile representation and at least one of said identified style of clip-on imbalance correction weights to an operator.

23. A method for identifying a type of clip-on imbalance correction weight for application to a vehicle wheel rim lip, comprising the steps of:
determining profiles of inside and outside surfaces of a lip of the vehicle wheel rim;
comparing said identified profiles with a plurality of stored clip-on imbalance correction weight clip profiles; and
responsive to said comparison, identifying at least one style of clip-on imbalance correction weight for application to the vehicle wheel rim lip.

24. The method of claim 23 further including the step of dismounting a tire from the vehicle wheel rim prior to determining said profile of said inside surface of said wheel rim lip.

25. An improved wheel balancer having a balancer processing system, spindle shaft for mounting a vehicle wheel assembly consisting of at least a vehicle wheel rim for rotation thereon, and a wheel rim measurement system for acquiring data representative of the characteristics of the wheel rim lip, the improvement comprising:
wherein the balancer processing system is configured with program instructions to compare data from the wheel rim measurement system which is representative of a wheel rim lip characteristics with a plurality of stored imbalance correction weight profiles; and
wherein the balancer processing system is further configured with program instructions responsive to said comparison to identify a style of imbalance correction weight for application to the vehicle wheel rim lip.

26. The improved wheel balancer of claim 25 wherein said data from the wheel rim measurement system is representative of a wheel rim lip thickness.

27. The improved wheel balancer of claim 25 wherein said data from the wheel rim measurement system is representative of a wheel rim lip contour.

28. A method for correcting an imbalance in a vehicle wheel assembly, comprising the steps of:
measuring an imbalance associated with the vehicle wheel assembly;
identifying a type of imbalance correction weight for application to the vehicle wheel assembly;
identifying at least one characteristic of said identified type of imbalance correction weight;
utilizing at least said identified characteristic and said measured imbalance to determine at least one placement location and imbalance correction weight amount for placement of an imbalance correction weight of the identified type on the vehicle wheel assembly.

29. The method of claim 28 wherein said at least one characteristic is a center of gravity of said identified type of imbalance correction weight.

30. The method of claim 28 wherein said at least one characteristic is the density per unit length of said identified type of imbalance correction weight.

31. The method of claim 28 wherein said at least one characteristic is a set of parameters from which a center of gravity can be determined for said identified type of imbalance correction weight.

32. An improved wheel balancer having a balancer processing system, spindle shaft for mounting a vehicle wheel assembly consisting of at least a vehicle wheel rim for rotation thereon, the improvement comprising:
wherein the balancer processing system is configured with a database of imbalance correction weight characteristics, said imbalance correction weight characteristics including parameters from which a center of gravity can be determined for at least one style of imbalance correction weight; and
wherein the balancer processing system is configured to utilize data stored in said database to determine an imbalance correction weight placement location on a vehicle wheel assembly.
